(19) United States
(12) Patent Application Publication
(10) Pub. No.: US 2006/0028676 A1
(43) Pub. Date: Feb. 9, 2006

(54) Device controller and method for controlling same, central controller and method for controlling same, control device, control program for device controller, control program for central controller, and storage medium storing the control programs

(76) Inventors: Kazuhiro Mizude, Soraku-gun (JP); Hideyuki Hiro, Tenri-shi (JP); Takashi Nakagawa, Nara-shi (JP); Naoki Kodama, Yamatokoriyama-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/196,646

(22) Filed: Aug. 3, 2005

(30) Foreign Application Priority Data
Aug. 6, 2004 (JP) 2004-231626

(51) Int. Cl. G06F 3/12

(52) U.S. Cl. 358/1.15

(57) ABSTRACT

An engine controller controls a plurality of devices in an image forming engine. The engine controller includes a communication interface to perform data communication with the main body controller, and a storage section for storing information. The storage section stores a character string-bit order lookup table, in which the order of arranged data for part of or all of a plurality of bit information items regarding a plurality of devices is associated with a plurality of character strings identifying the bit information items. A character string obtaining section sends out data with the character strings arranged in accordance with the arranged order, via a communication interface to the main body controller.

This Nonprovisional application claims priority under U.S.C. § 119(a) on Patent Application No. 231626/2004 d in Japan on Aug. 6, 2004, the entire contents of ch are hereby incorporated by reference.

### FIELD OF THE INVENTION

The present invention relates to a device controller controlling a plurality of devices and a method for rolling the device controller; a central controller for controlling the device controller and a method for controlling the central controller: a control apparatus including the devices, the device controller and the central controller; a device controller control program controlling; a central controller control program; and a storage medium storing the control programs. More particularly, the present invention relates to an engine controller for controlling an image forming engine, which is an engine for forming an image; a main body controller for controlling the engine controller and various other components in an integrated fashion; an image forming apparatus including the image forming engine, the engine controller, and the main body controller; and the like.

### BACKGROUND OF THE INVENTION

A conventional image forming apparatus such as a printer includes various components such as an image forming engine, an engine controller, a main body controller, optional devices and the like. In order to operate the image forming apparatus as desired, data communication between these components is important.

For example, Patent Document 1 (Japanese Unexamined Patent Publication No. 358177/2002 (published on Dec. 13, 2002)) describes an image forming apparatus in which a program is downloaded from a printer controller to an engine controller so as to rewrite a program (firmware) stored in a flash memory of the engine controller.

Patent Document 2 (Japanese Unexamined Patent Publication No. 200639/2003 (published on Jul. 15, 2003)) describes an image recording apparatus in which predetermined option information is obtained from each of connected optional devices and stored, and in which each optional device is recognized based on the stored option information. For each of the recognized optional devices, identification information is issued, and the optional devices are controlled in an integrated fashion based on the issued identification information. From each of the optional devices, image information is also obtained, and the option information and the image information obtained from each of the optional devices are displayed on an operating section.

An image forming engine in a conventional image forming apparatus such as a printer includes a number of loaded units such as a main body power unit, a conveying unit, a sheet feeding unit, an LSU (Laser Scan Unit) and the like, and a number of sensor units such as a sensor unit for the main body, a sensor unit for manual paper feeding, a sensor unit for a tandem method and the like. Each of the units includes from several to about a dozen of devices, which are directly controlled by the engine controller. Specifically the engine controller sends operation instructions to each device and obtains status information from each device.

Meanwhile, the main body controller sends data regarding the operation instructions or receives status data to and from the engine controller. The data contain organized information regarding each device of the unit. Therefore the main body controller and the engine controller are required to recognize a data location of information regarding a given device, i.e., to recognize which part of the data relates to which device.

In the conventional image forming apparatus, however, the data location of information regarding the device sometimes changes when the image forming engine or the engine controller is modified or corrected.

Note that, as used herein, the “modification” refers to changes made to improve the performance of the image forming engine or engine controller, for example, such as a speed of the print process, in the image forming apparatus. The term “modification” also refers to mechanical changes in the image forming apparatus, for example, such as modifying an image forming apparatus with only a single-sided printing capability to also perform duplex printing. The term “correction” refers to the correction of defects caused in the image forming engine or engine controller in the image forming apparatus.

In this case, in order for the main body controller to operate a desired device in a desired manner or obtain a status of a desired device, the main body controller needs to change its program in accordance with the change in the data location of information for the device.

Therefore, in the conventional image forming apparatus, the main body controller needs to be changed when the image forming engine or the engine controller is modified or corrected, which increases the cost of changing the main body controller.

The apparatus described in the Patent Document 1, however, does not need to change a program in the printer controller, because the modification and correction are complemented for by downloading a program from the printer controller (main body controller) to the engine controller and thereby rewriting a program (firmware) stored in a flash memory of the engine controller.

In this case, however, the printer controller needs to store or externally download a new program that complements for the modification or correction of the engine controller. In other words, whenever the engine or the engine controller is modified or corrected, a corresponding new program is required to be added.

### SUMMARY OF THE INVENTION

The present invention was made in view of the foregoing problems, and an object of the present invention is to provide a device controller and the like which does not require modification or correction of a central controller controlling the device controller, even when devices or the device controller controlling the devices are modified or corrected.

In order to achieve the above-mentioned object, the present invention provides a device controller for controlling a plurality of devices, the device controller including: a communication section for performing data communication with an external apparatus; a storage section for storing information, the storage section storing an order in which part of or all of a plurality of content information items regarding the plurality of devices are to be arranged in the data, and a plurality of identification information items, associated with the arranged order, identifying the content information items; and a control section for controlling an operation of the device controller, and including an identification information transmitting section for transmitting data in which the identification information items are arranged in accordance with the arranged order, via the communication section to the external apparatus.

According to the configuration, the identification information transmitting section transmits data in which a plurality of identification information items are arranged in accordance with the arranged order of the corresponding content information items, to an external apparatus. In this way, the content information items arranged in the data transmitted from the device controller can be associated by the external apparatus with appropriate identification information items. Thus, the external apparatus does not perform a process operation based on the content information specified by the identified positions in the data, but performs the operation based on the identification information appropriately associated with the content information. Consequently, no modification or correction of the central controller will be necessary even when the arranged order of the content information items in the data is changed as a result of modifying or correcting the devices and/or the device controller. There accordingly will be no effort or cost associated with the modification or correction.

According to the present invention, there is provided a central controller for controlling a device controller which controls a plurality of devices, the central controller including: a communication section for performing data communication with the device controller; a storage section for storing information, the storage section storing a plurality of identification information items for identifying a plurality of content information items regarding the plurality of devices; and a control section for controlling an operation of the central controller, and including: an arranged data obtaining section for obtaining data in which part of or all of the arranged identification information items are arranged, via the communication section from the device controller; and an arranged order associating section for associating (a) the order in which the content information items identified by the identification information items are arranged in the data with (b) the order in which the identification information items obtained by the arranged data obtaining section are arranged.

With the above-mentioned arrangement, the arranged order in the data is associated with the arranged order of the identification information items obtained by the arranged data obtaining section. Thus, the content information items arranged in the data transmitted from the device controller can be associated with appropriate identification information items. In other words, the central controller does not perform a process operation based on the content information specified by the identified positions in the data, but performs the operation based on the identification information appropriately associated with the content information. Consequently, no modification or correction will be necessary even when the arranged order of the content information items in the data is changed as a result of modifying or correcting the devices and/or the device controller. There accordingly will be no effort or cost associated with the modification or correction.

A control apparatus according to the present invention includes a plurality of devices, the device controller with the above-mentioned configuration, and the central controller with the above-mentioned configuration.

The control apparatus with the above-mentioned configuration can exhibit the same effects as the device controller and the central controller.

According to the present invention, there is provided a method for controlling a device controller controlling a plurality of devices, the device controller including: a communication section for performing data communication with an external apparatus; and a storage section for storing information, the storage section storing an order in which part of or all of a plurality of content information items regarding the plurality of devices are to be arranged in the data, and a plurality of identification information items, associated with the arranged order, identifying the content information items, the method including the step of transmitting data in which the identification information items are arranged in accordance with the arranged order, via the communication section to the external apparatus.

According to the above-mentioned method, data in which a plurality of identification information items are arranged in accordance with the arranged order of the corresponding content information items is transmitted to an external apparatus. Thus, the content information items arranged in data transmitted from the device controller can be associated by the external apparatus with appropriate identification information items. Therefore, the external apparatus does not perform a process operation based on the content information specified by the arranged positions in the data, but performs the operation based on the identification information appropriately associated with the content information. Consequently, no modification or correction of the external apparatus will be necessary even when the arranged order of the content information items in the data is changed as a result of modifying or correcting the devices and/or the device controller. There accordingly will be no effort or cost associated with the modification or correction.

According to the present invention, there is provided a method for controlling a central controller controlling a device controller which controls a plurality of devices, wherein the central controller includes: a communication section for performing data communication with the device controller; and a storage section for storing information, the storage section storing a plurality of identification information items for identifying a plurality of content information items regarding the plurality of devices, the method including the steps of: obtaining arranged data in which part of or all of the arranged identification information items are arranged, via the communication section from the device controller; and associating (a) the order in which the content information items identified by the identification information items are arranged in the data with (b) the order of the identification information items obtained by the step of obtaining arranged data.

According to the above-mentioned method, the arranged order of the content information items in the data is associated with the arranged order of the identification information items obtained by the step of obtaining arranged data. Thus, the content information items arranged in the data transmitted from the device controller can be associated with appropriate identification information items. In other words, the central controller does not perform a process operation based on the content information specified by the arranged positions in the data, but performs the operation based on the identification information appropriately associated with the content information. Consequently, no modification or correction will be necessary even when the arranged order of the content information items in the data is changed as a result of modifying or correcting the devices and/or the device controller. There accordingly will be no effort or cost associated with the modification or correction.

Other objects, features, and advantages of the present invention will be readily appreciated by the following description. The advantages of the present invention will be apparent from the detailed description provided below, with reference to the accompanying drawings.

### BRIEF DESCRIPTION OF THE DRAWINGS

FIG. 1 is a block diagram illustrating a schematic configuration of an engine controller in an image forming apparatus in the image forming system according to one embodiment of the present invention.

FIG. 2 is a block diagram illustrating a schematic configuration of the image forming apparatus.

FIG. 3 illustrates an example of a character string-bit order lookup table stored in a storage section of the engine controller.

FIG. 4 is a memory map illustrating how the character string-bit order lookup table is stored in the storage section.

FIG. 5 is a block diagram illustrating a schematic configuration of a main body controller in the image forming apparatus.

FIG. 6 is a block diagram illustrating a configuration of a main portion of the main body controller.

FIGS. 7(a) through 7(c) illustrate a table of a data configuration of a request for a character string sent from the main body controller to the engine controller.

FIG. 8 is illustrates a table of a data configuration of a character string notice sent from the engine controller to the main body controller in response to a request for a character string.

FIG. 9 illustrates an example of the character string notice in the form of a table.

FIG. 10 is a flow chart representing a process operation for a load test in the main body controller.

FIG. 11 is a flow chart representing a process operation for a sensor test in the main body controller.

FIG. 12 illustrates an example of a list of sensor-related character strings displayed on an operating unit of the image forming apparatus in a sensor test.

FIG. 13 is a flow chart representing a process operation of the main body controller, when there is a paper jam in the image forming engine.

FIG. 14 illustrates an example of display on the display screen of an operating unit, when there is a paper jam.

FIG. 15 is a flow chart representing a printing process operation, in which printer setting data are sent from the main body controller to the engine controller.

FIG. 16 is a block diagram illustrating a configuration of main portions of a conventional image forming apparatus.

### DESCRIPTION OF THE EMBODIMENTS

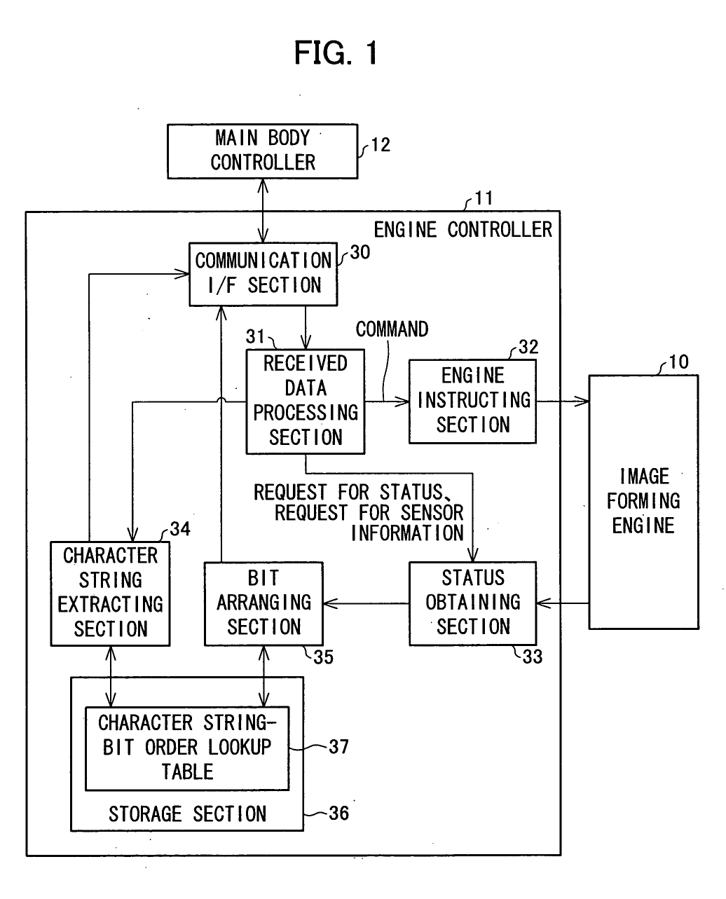

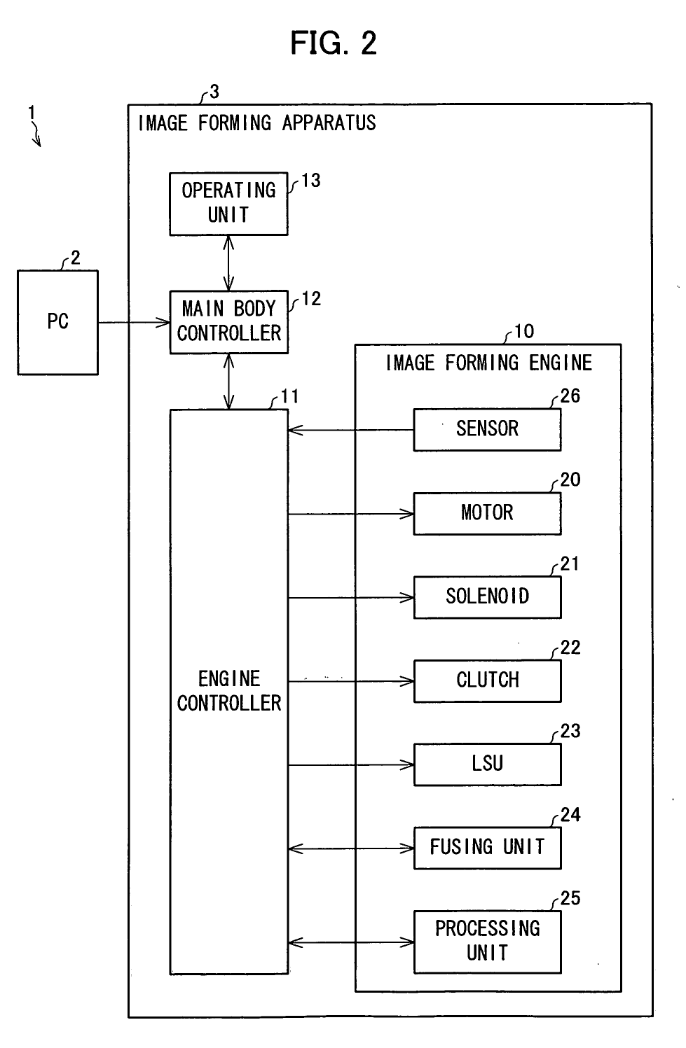

An embodiment of the present invention is described below with reference to FIGS. 1 through 15. FIG. 2 shows a schematic configuration of an image forming system of the present invention. As shown in FIG. 2, an image forming system 1 includes a personal computer 2 (PC) and an image forming apparatus (control apparatus) 3, such as a printer or a digital copier (MFP), which is communicably connected to the PC 2 and forms and generates an image based on image data or text data received from the PC 2.

The PC 2 and the image forming apparatus 3 have configurations similar to typical computers. Specifically, the PC 2 and the image forming apparatus 3 includes a processing unit (Central Processing Unit (CPU)), a storage unit, and an interface unit (I/F) which is an interface with external apparatuses. Various operations of the PC2 and the image forming apparatus 3 are performed by causing the processing unit to execute programs stored in the storage unit. The detailed configuration of the image forming apparatus 3 is described below.

As is shown in FIG. 2, the image forming apparatus 3 includes, an image forming engine 10, an engine controller 11, a main body controller 12, and an operating unit 13.

The main body controller 12 controls the image forming apparatus 3 in an integrated fashion. In this embodiment, the main body controller 12 converts text data received from the PC 2 into RGB image data and generates CMYK image data by performing image processing with respect to the converted data or RGB image data received from the PC 2. The generated CMYK image data is supplied to the engine controller 11.

In addition, the main body controller 12 sends setting data received from the PC 2 and/or the operating unit 13 to the engine controller 11. From the engine controller 11, the main body controller 12 also receives sensor data, which indicate status of various devices provided in the image forming engine 10, and sensor information.

The engine controller 11 controls the image forming engine 10 by primarily controlling various devices provided in the image forming engine 10. In the present embodiment the engine controller 11 receives CMYK image data of one page from the main body controller 12 and controls the image forming engine 10 in such a manner that an image is output onto a printing sheet based on the received data. The engine controller 11 also controls the image forming engine 10 based on the setting data received from the main body controller 12. The settings include, for example, selection of a sheet feeding tray, selection of duplex printing, selection of a sheet ejecting tray and the like.

Further, in response to requests from the main body controller 12, the engine controller 11 operates loaded devices in the image forming engine 10, or sends sensor data obtained from sensor devices and the loaded devices provided in the image forming engine 10.

The image forming engine 10 serves to actually form and output an image onto a printing sheet. In the case of a laser printer, the image forming engine 10 forms a latent image based on the image data onto a photoreceptor drum by a known electrophotographic process, and then transfers and fuses the latent image onto the sheet, thereby forming the image on the sheet. The image forming engine 10 therefore includes, as shown in FIG. 2, loaded devices such as a motor 20, a solenoid 21, a clutch 22, a LSU 23, a fusing unit 24, and a processing unit 25, as well as various sensor devices 26 (hereinafter simply referred to as “sensors”).

The operating unit 13 serves to display various types of information and receive various instructions from a user. In the operating unit 13, various display devices and operating devices, such as a touch panel, operating buttons and the like are provided.

Next, the engine controller 11 is described in more detail with reference to FIG. 1. FIG. 1 shows a schematic configuration of the engine controller 11. As shown in FIG. 1, the engine controller 11 includes a communication I/F section (communication section) 30, a received data processing section (control section) 31, an engine instructing section (control section) 32, a status obtaining section (control section) 33, a character string extracting section (control section, identification information transmitting section) 34, a bit arranging section (control section) 35, and a storage section (storage section) 36.

The communication I/F section 30 performs data communication with the main body controller 12. The communication I/F section 30 is provided with a parallel interface section for receiving image data from the main body controller 12, and a serial interface section for sending and receiving other data. In other words, image data is transmitted in parallel, while other data are serially transmitted.

The received data processing section 31 performs various processes according to data received via the communication I/F section 30 from the main body controller 12, then transmits data to each block. Specifically, upon receiving a command for operating the loaded devices of the image forming engine 10, the data processing section 31 transmits the command to the instructing section for the engine 32. Further, upon receiving a sensor information request asking for status information of the loaded devices of the image forming engine 10, or asking for sensor information of the sensor devices (hereinafter the status information and sensor information will be collectively referred to as “sensor information”), the received data processing section 31 sends the request to the status obtaining section 33. In the present embodiment, upon receiving a request for a character string via the communication I/F section 30 from the main body controller 12, the received data processing section 31 sends the request for a character string to the character string extracting section 34.

The instructing section for the engine 32 instructs the various loaded devices of the image forming engine 10 based on commands received from the received data processing section 31. The image forming engine 10 can perform various operations in accordance with the instructions from the instructing section for the engine 32.

The status obtaining section 33 obtains sensor information from the various loaded devices and the sensors 26 provided in the image forming engine 10. The status obtaining section 33 extracts, from the sensor information obtained from the image forming engine 10, sensor information corresponding to the sensor information request received from the received data processing section 31, and then sends the extracted sensor information to the bit arranging section 35. In the present embodiment, the sensor information is bit information indicative of detection or non-detection of a sensor.

The storage section 36 includes a storage device such as RAM, ROM or the like so as to store various types of information. In the present embodiment, the storage section 36 includes a character string-bit order lookup table 37 which shows a corresponding relationship between character strings representing names of the various devices in the image forming engine 10, and bit order representing the arranged order of operation bits of various devices and sensor bits.

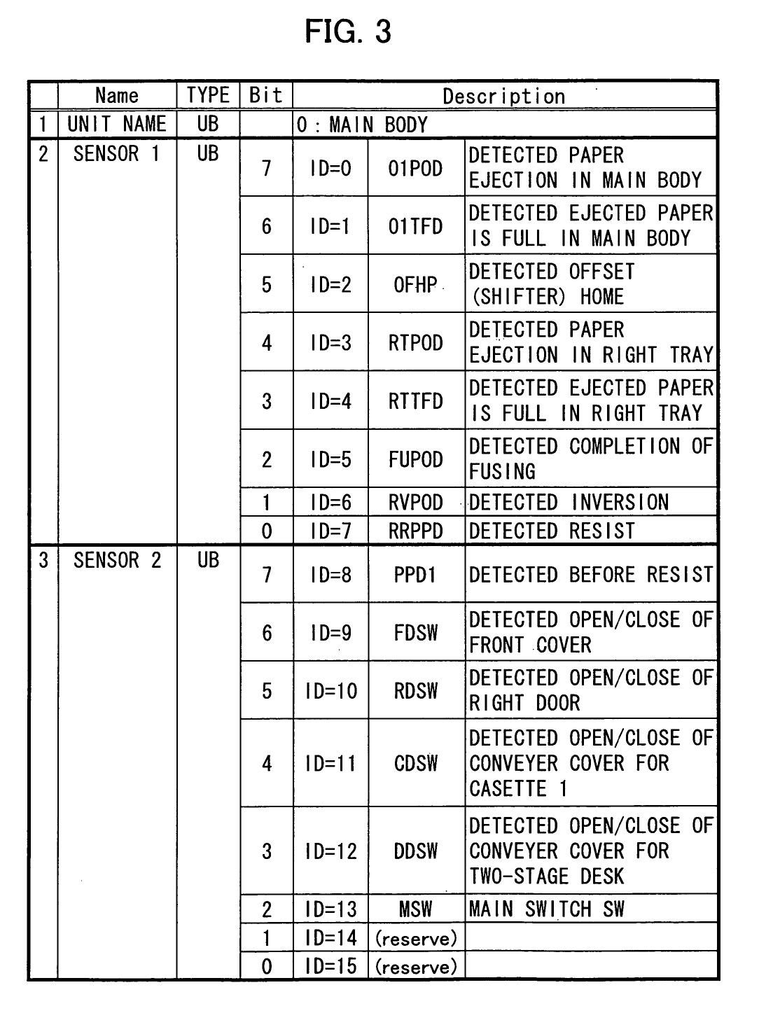

FIG. 3 shows an exemplary form of the character string-bit order lookup table 37. The character string-bit order lookup table 37 is stored in the storage section 36 for each unit. In the example shown in FIG. 3, the lookup table 37 represents the correspondence between bit order and character strings, concerning the sensors 26 provided in the main body unit. Fourteen sensors 26 are provided in the main body unit. As shown in FIG. 3, the character string-bit order lookup table 37 stores the order of bits representing detection or non-detection of the sensors 26, identification numbers (ID), and character strings representing names of the sensors 26.

In FIG. 3 “UB” represents a type of a byte of an unsigned integer byte (8 bit). ID=14 and ID=15 are indicated with “reserve”, which means that ID=14 and ID=15 are reserved for new sensors 26 to be added.

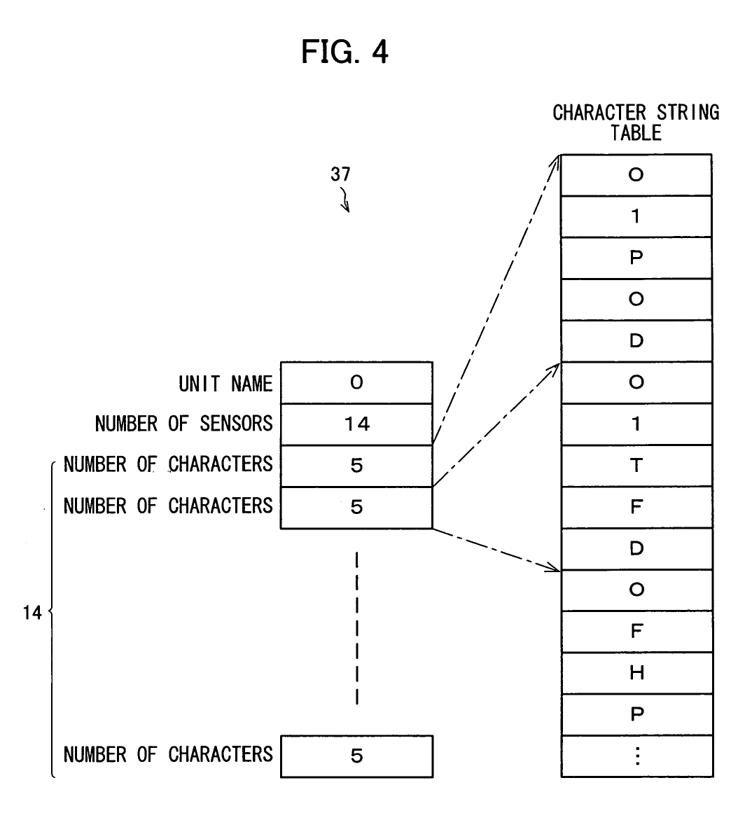

FIG. 4 shows how the character string-bit order lookup table 37 is stored in the storage section 36. As shown in FIG. 4, a unit name of each unit (a serial number for each unit) and the number of sensors provided in each unit are stored in a certain place of the storage section 36. Further, the number of characters in each character string representing a name of each sensor is stored for the number of sensors provided. In another place of the storage section 36, a character string table is stored. In the character string table, the character strings of the sensors provided in the unit are stored in accordance with the bit order.

The character string table can be easily looked up in accordance with the number of the characters in the character strings. For example, the character string “01POD” for a zero sensor of the main body unit (the bit order 7 and ID=0) corresponds to the first through the fifth characters of the character string table since the number of characters for the character string is 5. The character string “01TFD” for the first sensor corresponds to the 6th through 10th characters in the character string table since the number of the characters for the character string is 5. Thus a character string for the n-th sensor corresponds to the p-th through q-th characters, in which n is an integer of 0 or more than 0, p is 1 plus the sum of the characters of all sensors up to the (n−1)th sensor, and q is the sum of the characters of all sensors up to the n-th sensor.

FIG. 3 and FIG. 4 show an example of the character string-bit order lookup table 37 for the sensors provided in the main body unit. Similar tables are provided for sensors provided in other units and for the loaded devices.

Referring to FIG. 1, upon receiving a request for a character string from the received data processing section 31, the character string extracting section 34 extracts from the lookup table 37, in the bit order, respective character strings of the loaded devices or sensor devices contained in the corresponding unit. The character string extracting section 34 also sends data representing the extracted character strings via the communication I/F section 30 to the main body controller 12.

The bit arranging section 35 arranges sensor information (bit information) received from the status obtaining section 33, referring to the lookup table 37. The bit arranging section 35 generates sensor data including the arranged bit, and sends the generated sensor data via the communication I/F section 30 to the main controller 12.

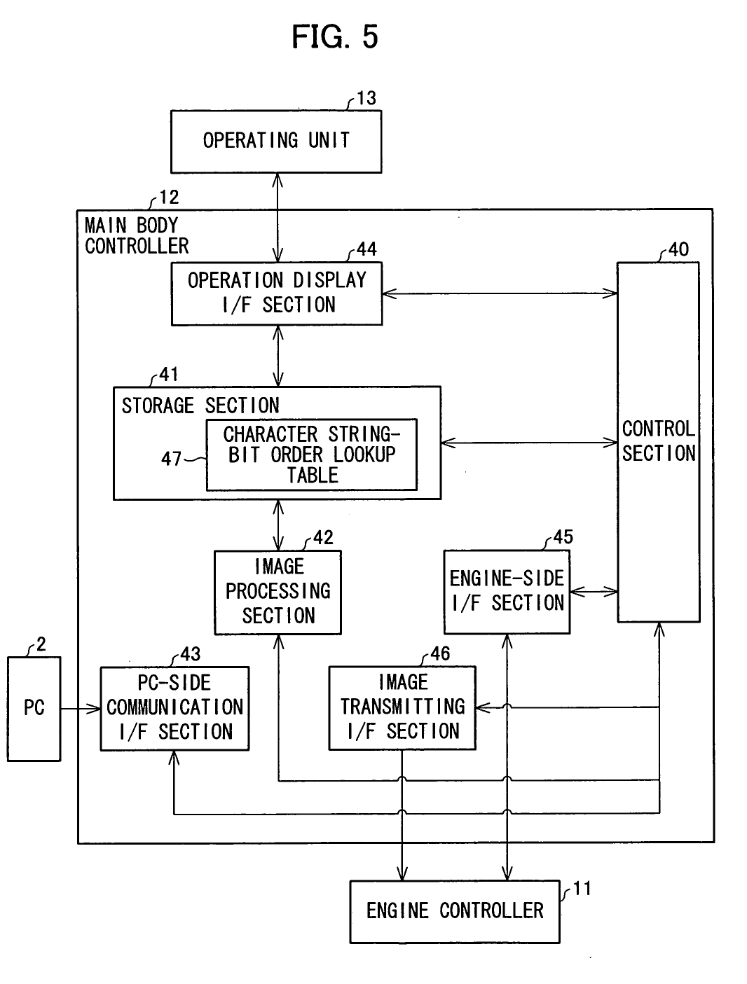

Next, the main body controller 12 is described in detail with reference to FIGS. 5 through 9. FIG. 5 illustrates a schematic configuration of the main body controller 12. As shown in FIG. 5, the main body controller 12 includes a control section (control section, display control section) 40, a storage section (storage section) 41, an image processing section 42, a PC-side communication I/F section 43, an operation display I/F section 44, an engine-side communication I/F section (communication section) 45, and an image transmitting I/F section 46.

The control section 40 controls the respective components of the main body controller 12 in an integrated fashion. The control section 40 will be described later in detail.

The storage section 41 stores various programs and data. In the present embodiment, the storage section 41 stores a character string-bit order lookup table 47. The lookup table 47 is analogous to the lookup table 37 (shown in FIGS. 3 and 4) stored in the storage section 36 of the engine controller 11.

With respect to the image data sent from the PC 2, the image processing section 42 performs image processing in such a manner as to allow the image forming engine 10 to form a desired image. Specifically, based on instructions from the control section 40, the image processing section 42 performs various types of image processing on image data sent from PC 2, by reading it from the storage section 41. The image processing section 42 stores the processed image data in the storage section 41.

The PC-side communication I/F section 43, the operation display I/F section 44, and the engine-side communication I/F section 45 perform data communication with the PC 2, the operating unit 13 and the engine controller 11, respectively. Each of the I/F sections 43, 44, and 45 typically performs serial data communication but may perform parallel data communication.

The image transmitting I/F section 46 sends image data to the engine controller 11. Specifically, the image transmitting I/F section 46 sends the processed image data, which is received via the control section 40 from the storage section 41, to the engine controller 11 in parallel.

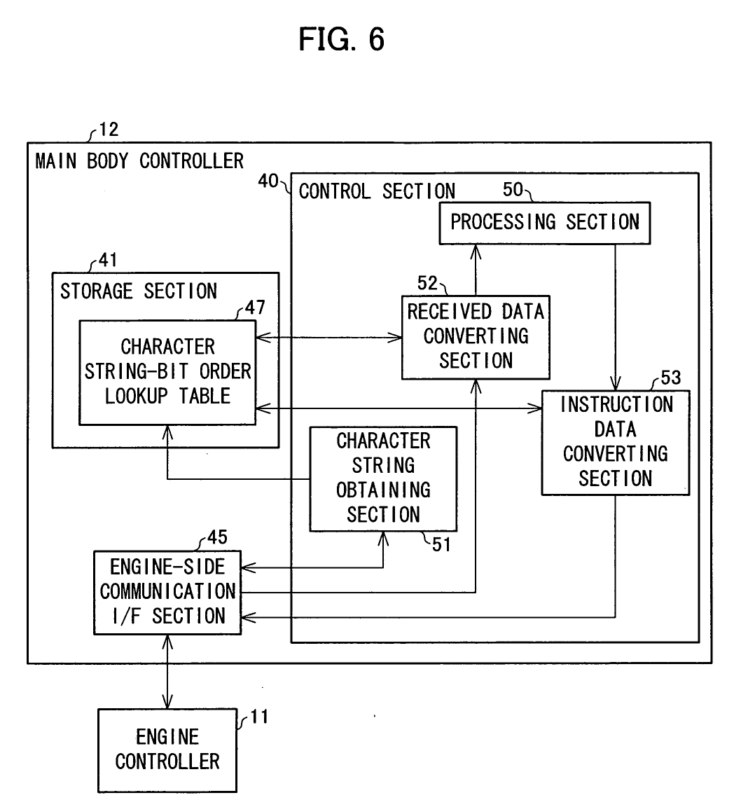

FIG. 6 shows a main portion of the main body controller 12, particularly the configuration in the control section 40 relating to data communication with the engine controller 11. As shown in FIG. 6, the control section 40 includes a processing section (instruction data creating section) 50, a character string obtaining section (arranged data obtaining section, arranged order associating section) 51, a received data converting section (status data obtaining section, identification information associating section) 52 and the instruction data converting section 53.

The processing section 50 performs various types of processing in order to control operations of the main body controller 12. In addition, the processing section 50 generates instruction data for operating various devices in the image forming engine 10, and obtains status data indicative of status of the various devices in the image forming engine 10.

The character string obtaining section 51 sends a request for a character string regarding the devices via the engine-side communication I/F section 45 to the engine controller 11, so as to obtain the character strings regarding the devices in a bit order via engine-side communication I/F section 45 from the engine controller 11. The character string obtaining section 51 causes the obtained character strings to be stored in the lookup table 47.

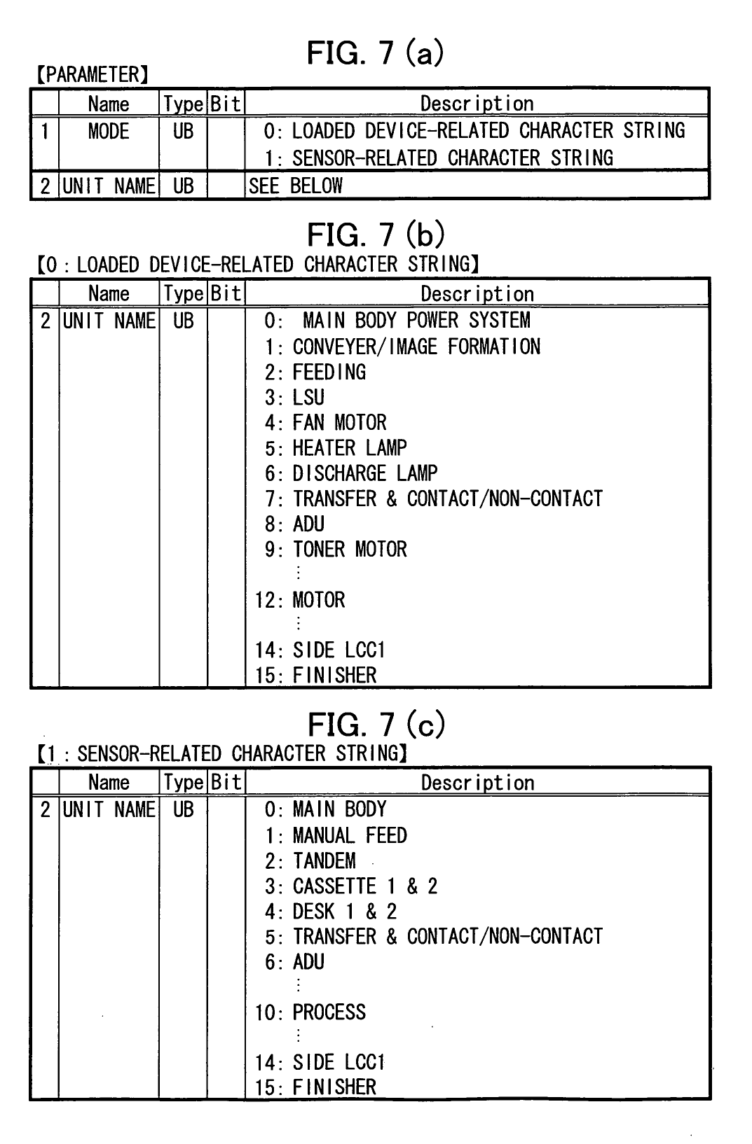

FIGS. 7(a) through 7(c) show a data configuration of the request for a character string in the form of a table. As shown in FIG. 7(a), the request for a character string includes a mode and a unit name (name of a unit) as parameters. The mode represents whether the request is related to a loaded device-related character string or to a sensor-related character string. This is required because the unit for the loaded devices as shown in FIG. 7(b) and the unit for the sensors as shown in FIG. 7(c) are different from each other. If the mode is a loaded device-related character string, one of the unit names shown in FIG. 7(b) is selected. If the mode is a sensor-related character string, one of the units shown in FIG. 7(c) is selected. The loaded device-related character string and the sensor-related character string representing a mode, and each unit name under the unit name are numbered, and therefore the actual request for a character string includes the mode and the unit name with corresponding numbers.

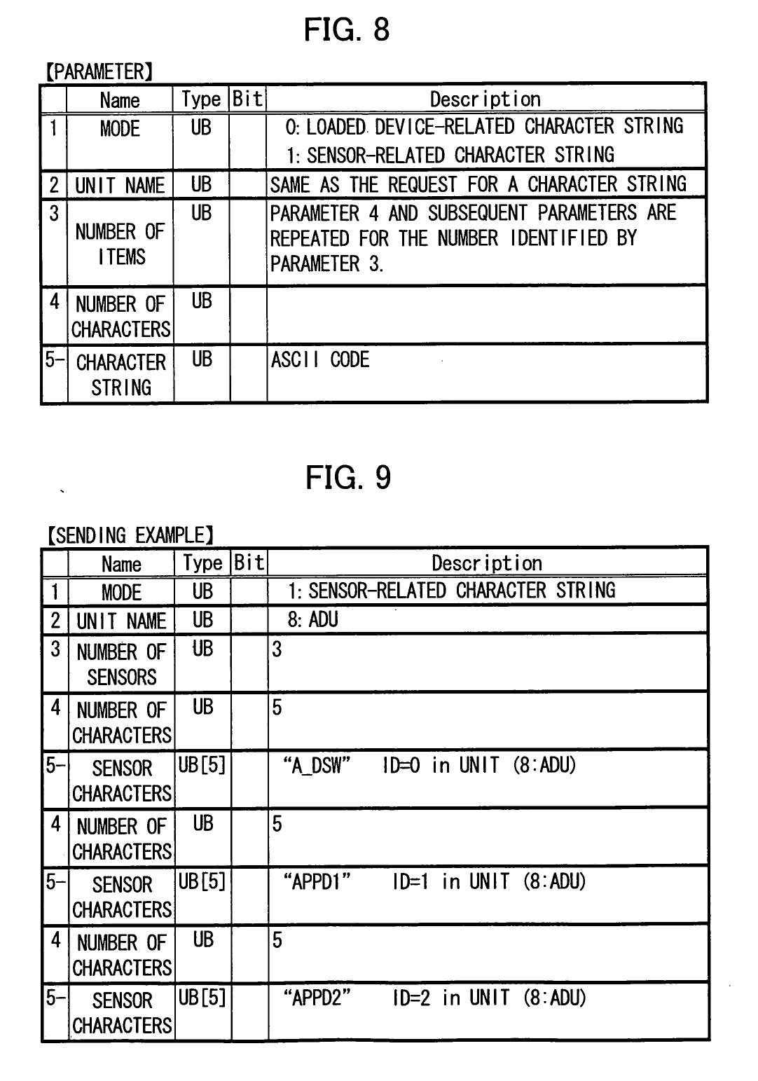

FIG. 8 shows in the form of a table a data configuration of a character string notice sent from the engine controller 11 to the main controller 12 in response to the request for a character string. As shown in FIG. 8, the character string notice includes a mode, a unit name, the number of sensors or devices, the number of characters, and a character string as parameters. The mode and the unit name are the same as those in the request for a character string. The number of sensors or devices, the number of characters, and the character string are the same as those shown in FIGS. 3 and 4. The actual character string notice includes the number of sensors or devices, and the number of characters in numbers, while it includes the character string in ASCII code (American Standard Code for Information Interchange).

FIG. 9 shows an example of the character string notice shown in FIG. 8. The character string notice shown in FIG. 9 includes three character strings “A_DSW”, “APPD1” and “APPD2” from three sensors in an Auto Duplex Unit (sheet reversing device).

With reference to FIG. 6, upon receiving status data via the engine-side communication I/F section 45 from the engine controller 11, the received data converting section 52 associates each bit of the status data with a character string, by referring to the lookup table 47 in the storage section 41, and then sends the associated data to the processing section 50. The processing section 50 thus can process the received data based on the character string.

Upon receiving instruction data created by the processing section 50 based on the character string, the instruction data converting section 53 converts the character strings in the instruction data into an appropriate bit order based on the lookup table 47 in the storage section 41. The instruction data converting section 53 sends the converted instruction data via the engine-side I/F section 45 to the engine controller 11.

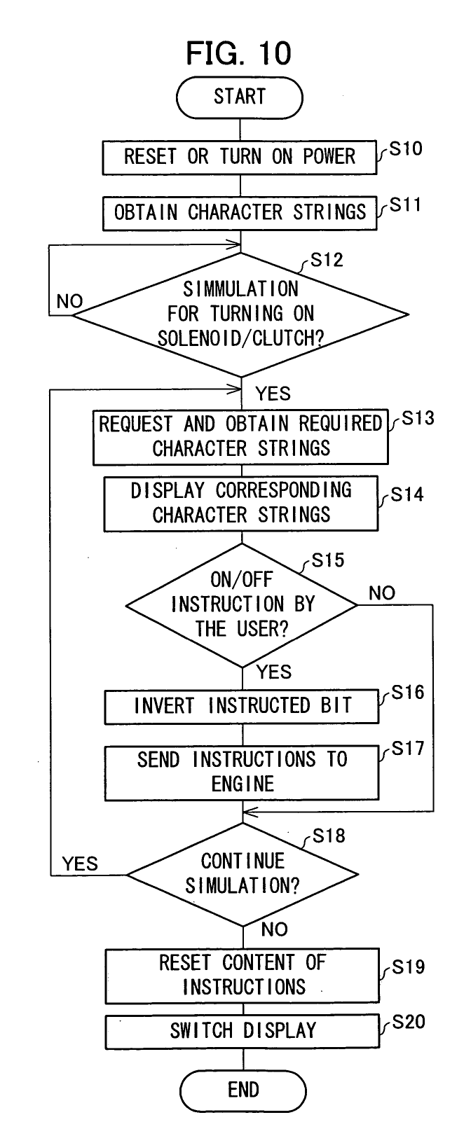

The processing operation in the main body controller 12 with the above-mentioned configuration is described below with reference to FIGS. 10 through 14. FIG. 10 shows a process operation of a load test on a clutch and solenoid. As shown in FIG. 10, with the image forming apparatus 3 turned on or reset (step S10, hereinafter may be referred to simply as “S10” as are other steps), the character string obtaining section 51 sends a request for character strings to the engine controller 11, thereby obtaining character strings for the various devices (S11). The main body controller 12 preferably obtains all character strings regarding devices required for the control operations. Alternatively, the main body controller 12 may obtain all character strings for all devices in the image forming engine 10.

Next, the system waits till a simulation (SIM) for turning on the solenoid and clutch is selected (S12). With the simulation selected, the character string obtaining section 51 sends to the engine controller 11 a request for character strings regarding the devices required for the simulation, thereby obtaining the character strings (S13). In the case that all character strings for all devices are obtained in step S11, step S13 is not necessary.

Next, character strings corresponding to the solenoid and clutch are displayed on the operating unit 13 (S14). Here, if a user enters ON/OFF instructions through the operating unit 13 (YES in S15), the corresponding bits in the instruction data are inverted (S16), and then the instruction data is sent to the engine controller 11 (S17). In this way, the solenoid and clutch in the image forming engine 10 can be turned on or off in accordance with user instructions.

Thereafter (after S17 or NO in S15), if the simulation is to be continued (YES in S18), steps S13 through S17 are repeated. If the simulation is not continued (NO in S18), instruction data is sent to reset the user instructions (S19), and the display in the operation unit 13 is switched to default display (S20). The processing operation for the load test is then finished.

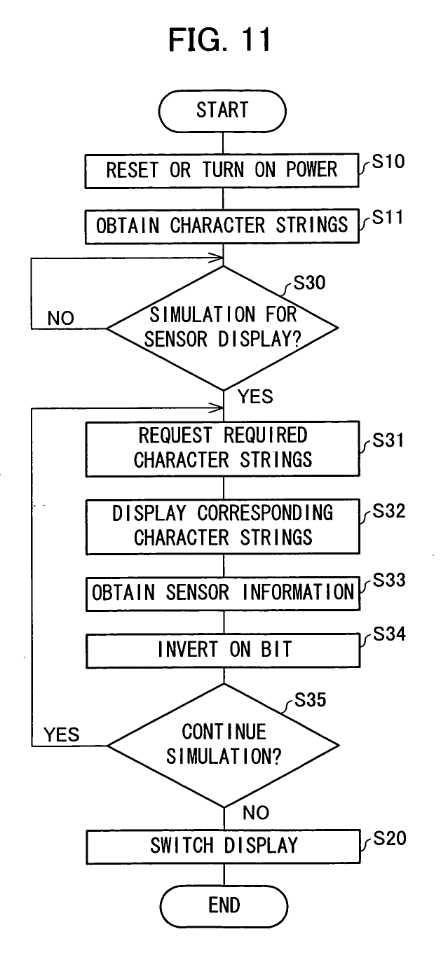

FIG. 11 shows the process operation for a sensor test. As shown in FIG. 11, with the image forming apparatus 3 turned on or reset (S11), the character string obtaining section 51 sends a request for character strings to the engine controller 11, so as to obtain character strings for the various devices (S11). These steps are the same as those shown in FIG. 10.

Next, the system waits till a simulation for sensor display is selected (S30). If the simulation is selected, the character string obtaining section 51 sends to the engine controller 11 a request for character strings regarding devices required for the simulation, so as to obtain the character strings (S31). In the case that all character strings regarding all devices are obtained in step S11, step S31 is not necessary.

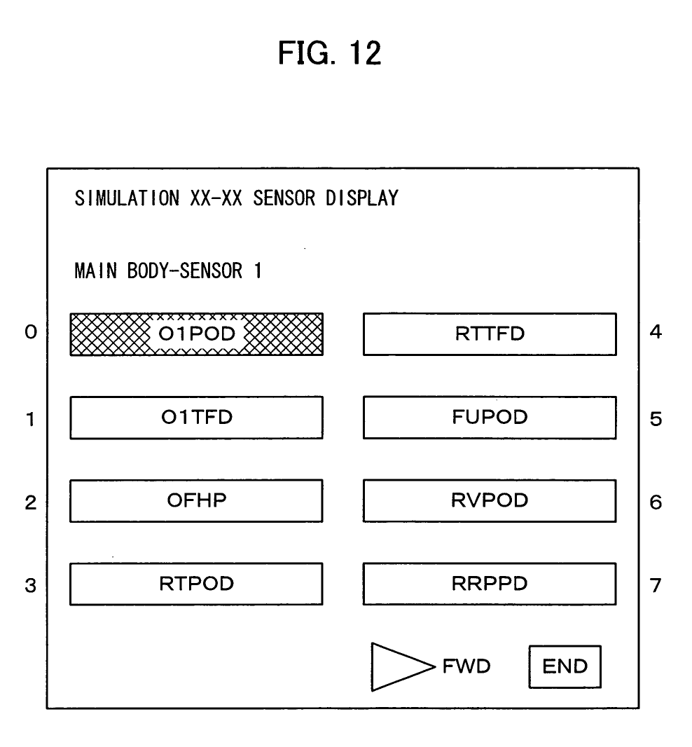

Next, character strings corresponding to the sensor are displayed on the operating unit 13 (S32). FIG. 12 shows an example of a list of sensor-related character strings displayed on the display screen of the operating unit 13. In FIG. 12, sensor-related character strings for the sensor 1 of the main body unit shown in FIG. 3 are displayed. By pressing down an arrow button FWD, the sensor-related character strings for the sensor 2 of the main body unit are displayed.

Next, instruction data requesting sensor information is sent to the engine controller 11 so as to obtain the sensor data (sensor information) (S33). Then, if a bit corresponding to a sensor in the obtained sensor data is ON, which means some information has been detected, the sensor-related character string corresponding to the ON bit is displayed inverted (S34). In this way, the user can recognize that some information has been sent from the sensor. In the example shown in FIG. 12, the character string “01POD” is displayed inverted. The inverted display is illustrated as a shaded portion in FIG. 12.

If the simulation is to be continued (YES in S35), steps S31 through S34 are repeated. If the simulation is not continued (NO in S35), the display in the operation unit 13 is switched to default display by, for example, pressing the END button on the display screen of the operating unit 13 (S20). The processing operation for the sensor test is then finished.

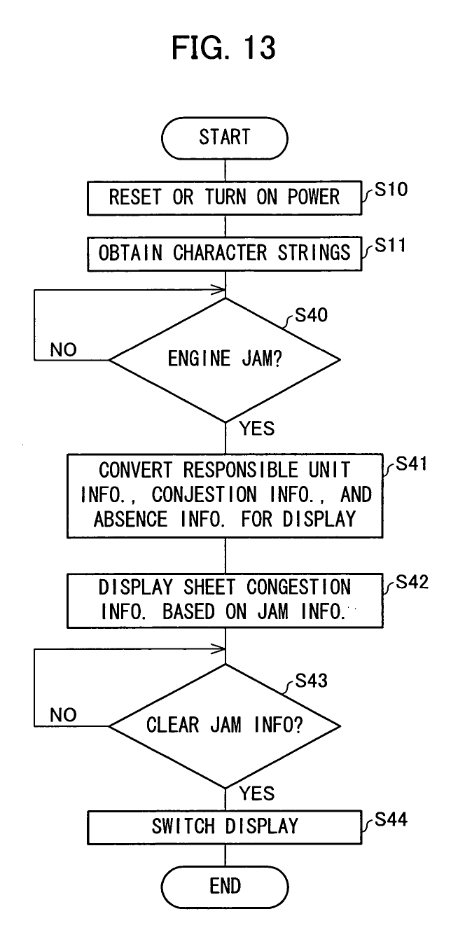

FIG. 13 shows a process operation for a paper jam which might occur in the image forming engine 10 during the operation of the image forming apparatus 3. As shown in FIG. 13, with the image forming apparatus 3 turned on or reset (S11), the character string obtaining section 51 sends a request for character strings to the engine controller 11, so as to obtain character strings for the various devices (S11). These steps S10 and S11 are the same as those shown in FIG. 10.

Then, the system waits till there is a paper jam in the image forming engine 10 (S40). The presence or absence of a paper jam can be found depending on whether there is inversion of a bit in the sensor data. When there is a paper jam, a bit in the sensor data is converted to a sensor-related character string. In this way, it is possible to grasp information concerning a unit primarily responsible for the paper jam, as well as congestion information and absence information of sheets. From the paper jam information, a display message is generated, and is displayed on the display screen of the operating unit 13 (S41).

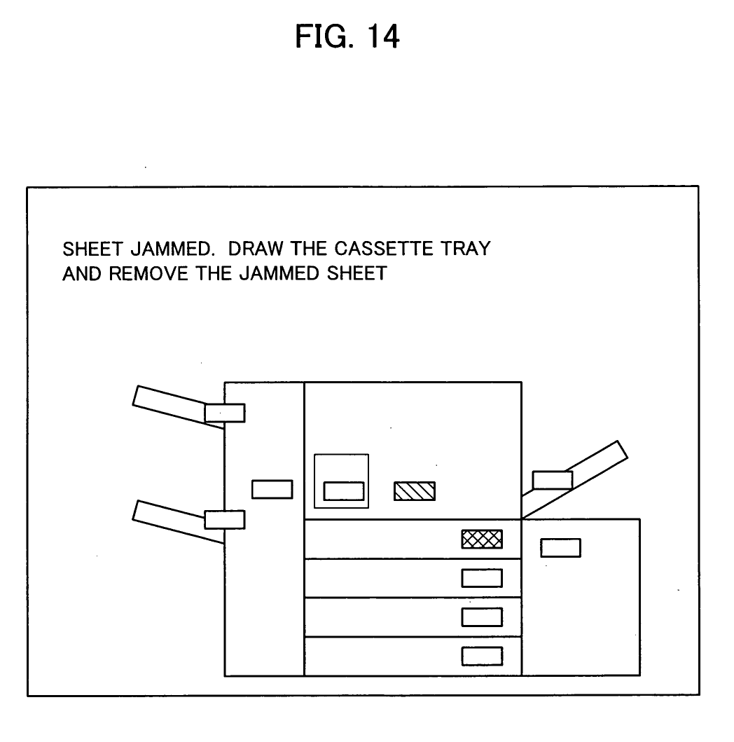

FIG. 14 shows an exemplary display screen of the operating unit 13 in the presence of a paper jam. As shown in FIG. 14, an external appearance of the image forming apparatus 3 is displayed on the display screen, together with the location of the unit causing the paper jam. The message is also displayed on the display screen.

Next, based on the paper jam information, congestion information of sheets is displayed (S42). In the example of FIG. 14, part of or all of the area corresponding to the sheet feeding tray are inverted, thereby informing the user that there is a congestion of sheets in the sheet feeding tray.

Then, the system waits until the congested sheet is removed by the user and the paper jam information is cleared (S43). With the paper jam information cleared, the display in the operation unit 13 is switched to default display (S20). The processing operation for a paper jam is then finished.

As mentioned above, in the image forming apparatus 3 according to the present embodiment, the character string extracting section 34 of the engine controller 11 sends data of a plurality of character strings which has been arranged in accordance with the order of the corresponding bit information, to the main body controller 12. Therefore, in the main body controller 12, the bit information arranged within the data sent from the engine controller 11 can be related to a suitable character string.

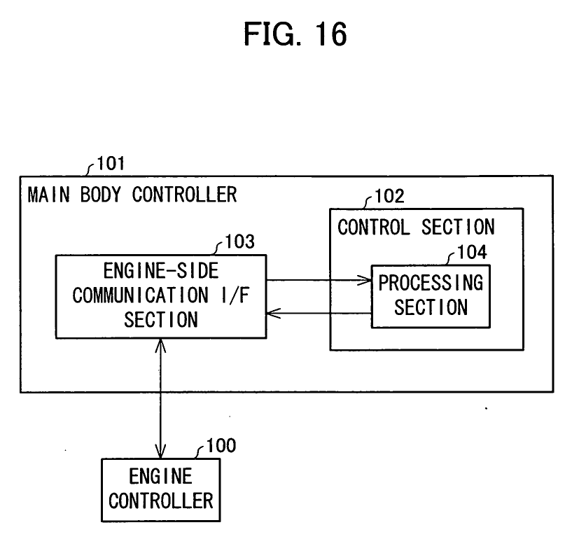

FIG. 16 shows a conventional main body controller 101. In the conventional main body controller 101, the instruction data created by a processing section 104 in a control section 102 is sent via an engine-side communication I/F section 103 to an engine controller 100. The sensor data is received via the engine-side communication I/F section 103 from the engine controller 100.

In this case, the main body controller 101 generates instruction data or processes sensor data based on the order of bit information in the data. Therefore, if the order of bit information in the data is changed as a result of modifying or correcting the engine controller 100, the main body controller 101 is required to be modified or corrected accordingly.

On the contrary, in the image forming apparatus 3 according to the present embodiment, the main body controller 12 does not operate in accordance with the bit information specified by the location arranged in the data, but rather operates in accordance with the character strings suitably corresponding to the bit information. Therefore, even when the arranged order of bit information in the data is changed as a result of modifying or correcting the image forming engine 10 and/or the engine controller 11, modification or correction of the main body controller 12 is not required. As a result, there will not be required any effort or cost associated with modification or correction.

The invention being thus described, it will be obvious that the same way may be varied in many ways. Such variations are not to be regarded as a departure from the spirit and scope of the invention, and all embodiments combining the modified technical means in the scope of the claims would be included within the scope of the claims.

For example, in printing, the main body controller 12 sends the image data to the engine controller 11, and also sends printer setting data which includes various print-setting information such as selection of a sheet feeding tray, selection of duplex printing, selection of a sheet ejecting tray and the like, to the engine controller 11. The engine controller 11 performs control functions of the image forming engine 10 based on the received printer setting data.

Here, if the bit location of printer setting information of the printer setting data is changed as a result of modifying the engine controller 11, a program in the main body controller 12 is required to be modified accordingly.

Therefore, besides the character strings identifying various devices in the image forming engine 10, it is preferable that character strings identifying the control functions furnished in the engine controller 11 be sent from the engine controller 11 to the main body controller 12 in the order in which respective pieces of information concerning the control functions are arranged in the data.

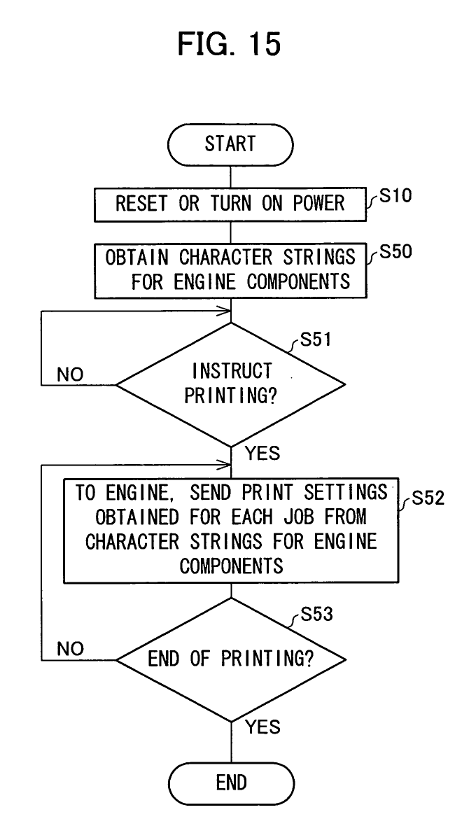

FIG. 15 shows a process operation for printing in which the printer setting data is sent from the main body controller 12 to the engine controller 11. As shown in FIG. 15, with the image forming apparatus 3 turned on or reset (S10), the character string obtaining section 51 sends a request for character strings to the engine controller 11, so as to obtain character strings regarding various devices as well as the character strings for identifying components of the engine controller 11 (S50).

Next, the system waits for print instructions (S51). With print instructions, printer setting data, in which printer settings are arranged based on the character strings for each printing job (JOB), is sent to the engine controller 11 (S52). Thus, printing in accordance with the printer setting data can be performed.

Step S52 is repeated until the printing is finished. Then, the processing operation for the printing is finished.

In the above-mentioned embodiment, a character string is used as identification information, but any type of information recognizable by the engine controller 11 and the main body controller 12 may be used instead. However, the character string is preferable, because the user can easily understand the content from the character string. Further, with the character strings represented by the ASCII code, there will not be required any special processing for converting the identification information, displayed on the display screen of the operating unit 13 for example, into a form easily understandable by the user.

Furthermore, though the above-mentioned embodiment is described based on the image forming apparatus 3, the invention is also applicable to a scanner controller directly controlling a scanner engine, or to a device controller controlling any type of device.

In addition, each block in the engine controller 11 and the main body controller 12 may be realized by hardware logic, or by software utilizing a CPU as mentioned below.

In the latter case, the engine controller 11 and the main body controller 12 include: a CPU executing commands of control programs for realizing various functions; a ROM storing the control programs, a RAM to which the control programs are loaded, a storage device (recording medium), such as a memory, storing the control programs and the various data, and the like. An object of the present invention can be achieved by supplying a computer-readable storage medium in which software for realizing the above-mentioned functions, i.e., program codes (executable programs, intermediate code programs, and the source programs) of the control programs for the engine controller 11 and for the main body controller 12 are stored, to the engine controller 11 and the main body controller 12, and by causing the computers (or CPU, MPU) to read out and execute the program codes stored in the recording medium.

Examples of such a recording medium include: tapes such as a magnetic tape, a cassette tape and the like; disks including a magnetic disk such as a flexible disk, a hard disk and the like, and an optical disk such as CD-ROM, MO, MD, DVD, CD-R and the like; cards such as an IC card (including a memory card), an optical card and the like; and a semiconductor memory such as a mask ROM, EPROM, EEPROM, Flash ROM, and the like.

The engine controller 11 and the main body controller 12 may be configured to be connectable with a communication network, through which the program codes may be supplied to the engine controller 11 and the main body controller 12. As for this communication network, without limitation, the Internet, Intranet, Extranet, LAN, ISDN, VAN, CATV communications network, virtual private network, telephone lines network, mobile communications network, satellite communications network, or the like may be utilized. A transmission medium configuring the communication network includes, without limitation, a wired medium such as IEEE1394, USB, a power-line carrier, a CATV circuit, a telephone line, ADSL line, or the like, and the wireless medium, such as infra-red for an IrDA and a remote control system, the Bluetooth®, 802.11 wireless network, HDR, mobile telephone network, a satellite connection, terrestrial digital network or the like may be used. The present invention may be also realized by program codes that are transmitted electronically in the form of a carrier wave or a series of data signals.

According to the present invention, a device controller and a method for controlling the device controller; a central controller and a method for controlling the central controller: a control apparatus including the device controller and the central controller; a device controller control program; a central controller control program; and a storage medium storing the control programs includes the following features.

According to the present invention, there is provided a device controller for controlling a plurality of devices, the device controller including: a communication section for performing data communication with an external apparatus; a storage section for storing information, the storage section storing an order in which part of or all of a plurality of content information items regarding the plurality of devices are to be arranged in the data, and a plurality of identification information items, associated with the arranged order, identifying the content information items; and a control section for controlling an operation of the device controller, and including an identification information transmitting section for transmitting data in which the identification information items are arranged in accordance with the arranged order, via the communication section to the external apparatus.

Examples of a plurality of content information items regarding the plurality of devices include: information representing content of operation of respective devices; information representing content of status of respective device; information representing content of settings for controlling the plurality of devices, and the like. An example of the information representing content on operation of respective devices is ON/OFF information regarding loaded devices such as a motor, a solenoid, a clutch or the like. An example of the information representing status of respective devices is information concerning the detection or non-detection of a sensor device. Examples of the information representing content of settings for controlling the plurality of devices include various types of printer setting information for printing, such as selection of a sheet feeding tray, selection of duplex printing, selection of a sheet ejecting tray, and the like.

The arranged order and identification information items are associated with each other, for example, by storing the identification information items in the arranged order, or by preparing a table representing correspondence between arranged order and identification information items. The identification information transmitting section sends data in which the identification information items are arranged in accordance with the arranged order. This can be carried out in response to a request from the external apparatus, or at a predetermined timing, i.e., at the time when power is turned on or reset.

According to the configuration, the identification information transmitting section transmits data in which a plurality of identification information items are arranged in accordance with the arranged order of the corresponding content information items, to an external apparatus. In this way, the content information items arranged in the data transmitted from the device controller can be associated by the external apparatus with appropriate identification information items. Thus, the external apparatus does not perform a process operation based on the content information specified by the identified positions in the data, but performs the operation based on the identification information appropriately associated with the content information. Consequently, no modification or correction of the central controller will be necessary even when the arranged order of the content information items in the data is changed as a result of modifying or correcting the devices and/or the device controller. There accordingly will be no effort or cost associated with the modification or correction.

According to the present invention, there is provided a central controller for controlling a device controller which controls a plurality of devices, the central controller including: a communication section for performing data communication with the device controller; a storage section for storing information, the storage section storing a plurality of identification information items for identifying a plurality of content information items regarding the plurality of devices; and a control section for controlling an operation of the central controller, and including: an arranged data obtaining section for obtaining data in which part of or all of the arranged identification information items are arranged, via the communication section from the device controller; and an arranged order associating section for associating (a) the order in which the content information items identified by the identification information items are arranged in the data with (b) the order in which the identification information items obtained by the arranged data obtaining section are arranged.

With the above-mentioned arrangement, the arranged order in the data is associated with the arranged order of the identification information items obtained by the arranged data obtaining section. Thus, the content information items arranged in the data transmitted from the device controller can be associated with appropriate identification information items. In other words, the central controller does not perform a process operation based on the content information specified by the identified positions in the data, but performs the operation based on the identification information appropriately associated with the content information. Consequently, no modification or correction will be necessary even when the arranged order of the content information items in the data is changed as a result of modifying or correcting the devices and/or the device controller. There accordingly will be no effort or cost associated with the modification or correction.

In the case where the content information items indicate status of the plurality of devices, the central controller according to the present invention preferably includes: a status data obtaining section for obtaining status data including the content information items via the communication section from the device controller; and an identification information associating section for associating, based on the association made by the arranged order associating section, the content information items in the status data with the identification information items in accordance with the order of the content information items in the status data obtained by the status data obtaining section. In this case, the status of the devices can be suitably grasped.

The central controller according to the present information further includes a display section for displaying various types of information, and the control section preferably includes a display control section for controlling, based on content of the content information items, the display section so as to display the identification information items associated with the content information items. In this case, since the identification information associated with the content information is displayed, a user can easily grasp the status of each device from the identification information.

In the central controller according to the present invention, the storage section preferably stores position information of the plurality of devices associated with the identification information items. The display control section preferably controls the display section so as to display, based on the position information of a corresponding device, the identification information items respectively associated with the content information items. In this case, the identification information corresponding to the content information can be displayed at the corresponding positions of the devices, so that a user can intuitively recognize the status of the device.

In the case where the content information items indicate contents of operations of the plurality of devices, the control section in the central controller according to the present invention preferably includes: an instruction data creating section for creating, using the identification information items associated with the content information items corresponding to the plurality of devices, instruction data including instruction information concerning operations of the plurality of devices; and an instruction data converting section for converting, based on the association made by the arranged order associating section, the instruction data created by the instruction data creating section into instruction data including instruction information at the arranged position corresponding to the identification information items. In this case, the devices can be operated more appropriately based on the identification information.

A control apparatus according to the present invention includes a plurality of devices, the device controller, and the central controller.

The control apparatus with the above-mentioned configuration can exhibit the same effect as the device controller and the central controller.

The identification information items are preferably character strings representing contents of the plurality of content information items regarding the plurality of devices. In this case, a user can understand the content information easily from the identification information. The character string is preferably a word that directly describes the content of the content information, or an abbreviation for such words, so as to make the character string short.

Further, the character strings are preferably represented by character code. In this case, the identification information does not need to be processed into information which is easily recognizable by a user through the display section.

Further, according to the present invention, the devices are installed in an image forming engine, which is a mechanism for forming images, and the present invention can be effectively implemented when the present invention is applied to an image forming apparatus controlling the image forming engine to form images.

According to the present invention, there is provided a method for controlling a device controller controlling a plurality of devices, the device controller including: a communication section for performing data communication with an external apparatus; and a storage section for storing information, the storage section storing an order in which part of or all of a plurality of content information items regarding the plurality of devices are to be arranged in the data, and a plurality of identification information items, associated with the arranged order, identifying the content information items, the method including the step of transmitting data in which the identification information items are arranged in accordance with the arranged order, via the communication section to the external apparatus.

According to the above-mentioned method, data in which a plurality of identification information items are arranged in accordance with the arranged order of the corresponding content information items is transmitted to an external apparatus. Thus, the content information items arranged in data transmitted from the device controller can be associated by the external apparatus with appropriate identification information items. Therefore, the external apparatus does not perform a process operation based on the content information specified by the arranged positions in the data, but performs the operation based on the identification information appropriately associated with the content information. Consequently, no modification or correction of the external apparatus will be necessary even when the arranged order of the content information items in the data is changed as a result of modifying or correcting the devices and/or the device controller. There accordingly will be no effort or cost associated with the modification or correction.

According to the present invention, there is provided a method for controlling a central controller controlling a device controller which controls a plurality of devices, wherein the central controller includes: a communication section for performing data communication with the device controller; and a storage section for storing information, the storage section storing a plurality of identification information items for identifying a plurality of content information items regarding the plurality of devices, the method including the steps of: obtaining arranged data in which part of or all of the arranged identification information items are arranged, via the communication section from the device controller; and associating (a) the order in which the content information items identified by the identification information items are arranged in the data with (b) the order of the identification information items obtained by the step of obtaining arranged data.

According to the above-mentioned method, the arranged order of the content information items in the data is associated with the arranged order of the identification information items obtained by the step of obtaining arranged data. Thus, the content information items arranged in the data transmitted from the device controller can be associated with appropriate identification information items. In other words, the central controller does not perform a process operation based on the content information specified by the arranged positions in the data, but performs the operation based on the identification information appropriately associated with the content information. Consequently, no modification or correction will be necessary even when the arranged order of the content information items in the data is changed as a result of modifying or correcting the devices and/or the device controller. There accordingly will be no effort or cost associated with the modification or correction.

A device controller control program can cause a computer to operate as a control section of the device controller. A central controller control program can cause a computer to operate as a control section of the central controller. In addition, with the control program for the device controller and/or the control program for the central controller stored in a computer-readable recording medium, the program can be executed on any computer.

As described above, in the device controller according to the present invention, the content information items arranged in the data transmitted from the device controller can be associated with appropriate identification information items by an external apparatus such as a central controller. This enables the external apparatus to operate based on the identification information appropriately associated with the content information. Consequently, with the device controller according to the present invention, no modification or correction of the external apparatus will be necessary even when the arranged order of the content information items in the data is changed as a result of modifying or correcting the devices and/or the device controller.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

As mentioned above, the device controller and the central controller according to the present invention perform processing operations based on the identification information appropriately associated with the content information. With this arrangement, no modification or correction of an external apparatus is necessary even when the arranged order of content information items in the data is changed as a result of modifying or correcting the devices and/or the device controller.

Therefore, the device controller and the central controller according to the present invention are applicable not only to an image forming apparatus but also to a controller controlling any device such as a scanner device.

What is claimed is:

1. A device controller for controlling a plurality of devices, comprising:
a communication section for performing data communication with an external apparatus;
a storage section for storing information, the storage section storing an order in which part of or all of a plurality of content information items regarding the plurality of devices are to be arranged in the data, and a plurality of identification information items, associated with the arranged order, identifying the content information items; and
a control section for controlling an operation of the device controller, and including an identification information transmitting section for transmitting data in which the identification information items are arranged in accordance with the arranged order, via the communication section to the external apparatus.

2. A central controller for controlling a device controller which controls a plurality of devices, comprising:
a communication section for performing data communication with the device controller;
a storage section for storing information, the storage section storing a plurality of identification information items for identifying a plurality of content information items regarding the plurality of devices; and
a control section for controlling an operation of the central controller, and including:
an arranged data obtaining section for obtaining data in which part of or all of the arranged identification information items are arranged, via the communication section from the device controller; and
an arranged order associating section for associating (a) the order in which the content information items identified by the identification information items are arranged in the data with (b) the order in which the identification information items obtained by the arranged data obtaining section are arranged.

3. The central controller as set forth in claim 2,
wherein the content information items indicate status of the plurality of devices, and the central controller further comprises a display section for displaying various types of information, and
wherein the control section further comprises:
a status data obtaining section for obtaining status data including the content information items via the communication section from the device controller;
an identification information associating section for associating, based on the association made by the arranged order associating section, the content information items in the status data with the identification information items in accordance with the order of the content information items in the status data obtained by the status data obtaining section; and
a display control section for controlling, based on content of the content information items, the display section so as to display the identification information items associated with the content information items.

4. The central controller as set forth in claim 3,
wherein the storage section stores position information of the plurality of devices associated with the identification information items, and
wherein the display control section controls the display section so as to display, based on the position information of a corresponding device, the identification information items respectively associated with the content information items.

5. The central controller as set forth in claim 2,
wherein the content information items indicate contents of operations of the plurality of devices, and
wherein the control section further comprises:
an instruction data creating section for creating, using the identification information items associated with the content information items corresponding to the plurality of devices, instruction data including instruction information concerning operations of the plurality of devices; and
an instruction data converting section for converting, based on the association made by the arranged order associating section, the instruction data created by the instruction data creating section into instruction data including instruction information that corresponds in position to the identification information items.

6. A control apparatus comprising a plurality of devices, a device controller controlling the plurality of devices, and a central controller for controlling the device controller which controls the plurality of devices,
the device controller comprising:
a communication section for performing data communication with an external apparatus;
a storage section for storing information, the storage section storing an order in which part of or all of a plurality of content information items regarding the plurality of devices are to be arranged in the data, and a plurality of identification information items, associated with the arranged order, identifying the content information items; and
the control section for controlling an operation of the device controller, and including an identification information transmitting section for transmitting data in which the identification information items are arranged in accordance with the arranged order, via the communication section to the external apparatus,
the central controller comprising:
a communication section for performing data communication with the device controller;
a storage section for storing information, the storage section storing a plurality of identification information items for identifying a plurality of content information items regarding the plurality of devices; and
a control section for controlling an operation of the central controller, and including:
an arranged data obtaining section for obtaining data in which part of or all of the arranged identification information items are arranged, via the communication section from the device controller; and
an arranged order associating section for associating (a) the order in which the content information items identified by the identification information items are arranged in the data with (b) the order in which the identification information items obtained by the arranged data obtaining section are arranged.

7. The control apparatus as set forth in claim 6, wherein the identification information items are character strings representing contents of the plurality of content information items regarding the plurality of devices.

8. The control apparatus as set forth in claim 7, wherein the character strings are represented by character code.

9. The control apparatus as set forth in claim 6, wherein the devices are installed in an image forming engine which serves to form images, and wherein the control apparatus is an image forming apparatus controlling the image forming engine to form images.

10. A method for controlling a device controller controlling a plurality of devices,
wherein the device controller comprises:
a communication section for performing data communication with an external apparatus; and
a storage section for storing information, the storage section storing an order in which part of or all of a plurality of content information items regarding the plurality of devices are to be arranged in the data, and a plurality of identification information items, associated with the arranged order, identifying the content information items,
said method comprising the step of transmitting data in which the identification information items are arranged in accordance with the arranged order, via the communication section to the external apparatus.

11. A method for controlling a central controller controlling a device controller which controls a plurality of devices, wherein the central controller comprises:
a communication section for performing data communication with the device controller; and
a storage section for storing information, the storage section storing a plurality of identification information items for identifying a plurality of content information items regarding the plurality of devices, and
said method comprising the steps of:
obtaining arranged data in which part of or all of the arranged identification information items are arranged, via the communication section from the device controller; and
associating (a) the order in which the content information items identified by the identification information items are arranged in the data with (b) the order of the identification information items obtained by the step of obtaining arranged data.

12. A device controller control program for causing a computer to operate as a control section of a device controller which controls a plurality of devices,
the device controller comprising:
a communication section for performing data communication with an external apparatus;
a storage section for storing an order in which part of or all of a plurality of content information items regarding the plurality of devices are to be arranged in the data, and a plurality of identification information items, associated with the arranged order, identifying the content information items; and
a control section for controlling an operation of the device controller, and including an identification information transmitting section for transmitting data in which the identification information items are arranged in accordance with the arranged order, via the communication section to the external apparatus.

13. A central controller control program for causing a computer to operate as a control section of a central controller, the central controller controlling a device controller which controls a plurality of devices,
the central controller comprising:
a communication section for performing data communication with the device controller;
a storage section for storing a plurality of identification information items for identifying a plurality of content information items regarding the plurality of devices; and
a control section for controlling an operation of the central controller, and including:
an arranged data obtaining section for obtaining data in which part of or all of the arranged identification information items are arranged, via the communication section from the device controller; and
an arranged order associating section for associating (a) the order in which the content information items identified by the identification information items are arranged in the data with (b) the order in which the identification information items obtained by the arranged data obtaining section are arranged.

14. A computer-readable recording medium storing at least one of (I) a device controller control program for causing a computer to operate as a control section of a device controller, and (II) a central controller control program for causing a computer to operate as a control section of a central controller,
the device controller controlling a plurality of devices and comprising:
a communication section for performing data communication with an external apparatus;
a storage section for storing an order in which part of or all of a plurality of content information items regarding the plurality of devices are to be arranged in the data, and a plurality of identification information items, associated with the arranged order, identifying the content information items; and
a control section for controlling an operation of the device controller, and including an identification information transmitting section for transmitting data in which the identification information items are arranged in accordance with the arranged order, via the communication section to the external apparatus, and
the central controller controlling the device controller controlling a plurality of devices, and comprising:
a communication section for performing data communication with the device controller;
a storage section for storing a plurality of identification information items for identifying a plurality of content information items regarding the plurality of devices; and
a control section for controlling an operation of the central controller, and including:
an arranged data obtaining section for obtaining data in which part of or all of the arranged identification information items are arranged, via the communication section from the device controller; and
an arranged order associating section for associating (a) the order in which the content information items identified by the identification information items are arranged in the data with (b) the order in which the identification information items obtained by the arranged data obtaining section are arranged.
